(19) United States
(12) Patent Application Publication
(10) Pub. No.: US 2025/0171692 A1
(43) Pub. Date: May 29, 2025

(54) LIQUID CRYSTAL COMPOSITIONS AND DISPLAY PANELS USING THE SAME

(71) Applicant: TCL CHINA STAR OPTOELECTRONICS TECHNOLOGY CO., LTD., Shenzhen (CN)

(72) Inventors: Xiao LIU, Shenzhen (CN); Ji LI, Shenzhen (CN)

(73) Assignee: TCL CHINA STAR OPTOELECTRONICS TECHNOLOGY CO., LTD., Shenzhen (CN)

(21) Appl. No.: 18/399,581

(22) Filed: Dec. 28, 2023

(30) Foreign Application Priority Data
Nov. 28, 2023 (CN) 202311611826.7

(51) Int. Cl. C09K 19/44; C09K 19/12; C09K 19/30; C09K 19/34; G02F 1/137

(52) U.S. Cl. CPC C09K 19/44; C09K 19/12; C09K 19/126; C09K 19/3003; C09K 19/3028; C09K 19/3066; C09K 19/3405; C09K 19/3491; G02F 1/137; C09K 2019/3004; C09K 2019/301; C09K 2019/3013; C09K 2019/3016; C09K 2019/3036; C09K 2019/3037; C09K 2019/3408

(57) ABSTRACT

The present disclosure provides a liquid crystal composition and a display panel using the same. The liquid crystal composition includes a first compound represented by the following formula (I-A) or formula (I-B), a second compound represented by the following formula (II-A) or formula (II-B), a third compound represented by the following formula (III-A) or formula (III-B), and a fourth compound represented by the following formula (IV).

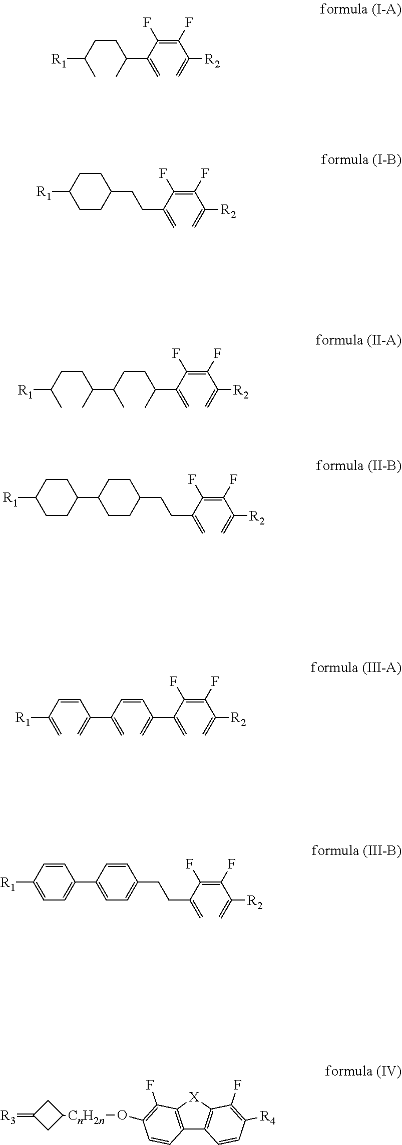

### CROSS-REFERENCE TO RELATED APPLICATION

The present disclosure claims the priority to and benefit of Chinese Patent Application No. 202311611826.7, filed on Nov. 28, 2023, the disclosure of which is incorporated herein by reference in its entirety.

### TECHNICAL FIELD

The present disclosure relates to the field of display, and in particular, to liquid crystal compositions and display panels using the same.

### BACKGROUND

Liquid crystal display panels use voltages applied to a liquid crystal layer to regulate the optical properties of liquid crystal materials in the liquid crystal layer, so as to realize the display function of the liquid crystal display panels. The physical properties of the liquid crystal materials in the liquid crystal layer, such as viscosity, clearing point, dielectric anisotropy, optical anisotropy, elastic coefficient, or the like, affect the display effect of the liquid crystal display panels such as response time. At present, the properties of liquid crystal materials used in the liquid crystal layer still need to be improved, and the difficulties in improving the response time of liquid crystal display panels are also faced.

Therefore, a liquid crystal composition and a display panel using the same are needed to solve the above-mentioned technical problem.

### SUMMARY

Embodiments of the present disclosure provide a liquid crystal composition including a first compound, a second compound, a third compound, and a fourth compound:

in which the first compound is represented by formula (I-A) or formula (I-B):

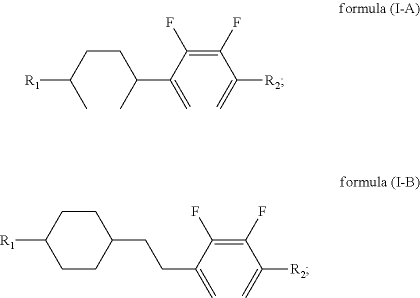

the second compound is represented by formula (II-A) or formula (II-B):

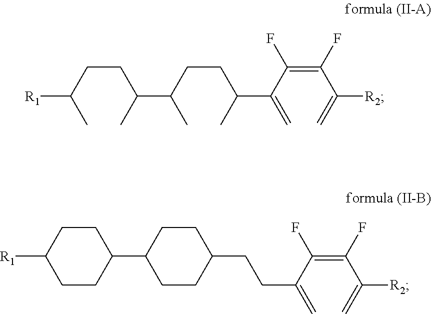

the third compound is represented by formula (III-A) or formula (III-B):

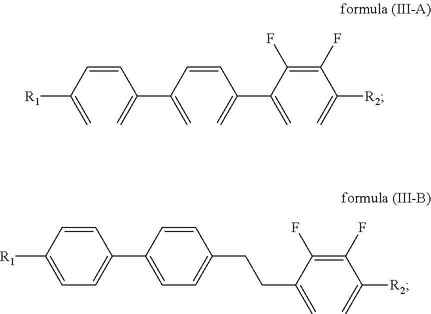

and
the fourth compound is represented by formula (IV):

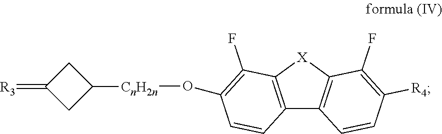

in which X is selected from O or S;
n is an integer greater than or equal to 0 and less than or equal to 7; and
R₁, R₂, R₃, and R₄ are independently selected from H, F, Cl, Br, I, CN, SCN, NCS, SF₅, a substituted or unsubstituted alkyl group having 1-15 carbon atoms, a substituted or unsubstituted alkoxy group having 1-15 carbon atoms, a substituted or unsubstituted alkenyl group having 2-15 carbon atoms, a substituted or unsubstituted alkenyloxy group having 2-15 carbon atoms, a substituted or unsubstituted alkynyl group having 2-15 carbon atoms, or a substituted or unsubstituted alkynyloxy group having 2-15 carbon atoms.

Embodiments of the present disclosure further provide a display panel including a first substrate, a second substrate disposed on the first substrate, and a liquid crystal layer between the first substrate and the second substrate;
in which the liquid crystal layer includes the above-mentioned liquid crystal composition.

### BRIEF DESCRIPTION OF THE DRAWINGS

In order to explain technical solutions in the embodiments of the present disclosure more clearly, the following description will briefly introduce the drawings needed to be used in description of the embodiments. Apparently, the drawings in the following description are only some embodiments of the present disclosure. For ordinary skilled in the art, other drawings can be obtained from these drawings without paying creative effort.

FIG. 1 is a flow chart of a method for preparing a liquid crystal composition provided by some embodiments of the present disclosure.

FIG. 2 is a schematic structural diagram of a display panel provided by some embodiments of the present disclosure.

### DETAILED DESCRIPTION

In combination with drawings in embodiments of the present disclosure, technical solutions in the embodiments of the present disclosure will be described clearly and completely. Apparently, the described embodiments are only part of the embodiments of the present disclosure, not all of them. Based on the embodiments of the present disclosure, all other embodiments obtained by those skilled in the art without creative effort belong to the scope of the present disclosure. In addition, it should be understood that specific embodiments described herein are only used to explain and illustrate the present disclosure and are not intended to limit the present disclosure. In the present disclosure, the directional terms, such as “up” and “down”, generally refer to upward and downward directions of the device, respectively, in actual use or working state, in particular directions in the drawings; and terms “inside” and “outside” are relative to the contour of the devices, unless otherwise described.

In the present disclosure, “substituted or unsubstituted” indicates that a defined group may be substituted or not be substituted. When the defined group is substituted, it can be understood that the defined group may be substituted by one or more substituent groups. The one or more substituent groups are independently selected from, but not limited to, F, Cl, Br, or I, unless otherwise specified.

At present, the properties of materials in the liquid crystal layer need to be improved, and it is difficult to improve display contrast and response time of liquid crystal display panels including the liquid crystal layer.

Embodiments of the present disclosure provide a liquid crystal composition including at least one first compound, at least one second compound, at least one third compound, and at least one fourth compound;
in which the first compound is represented by formula (I-A) or formula (I-B):

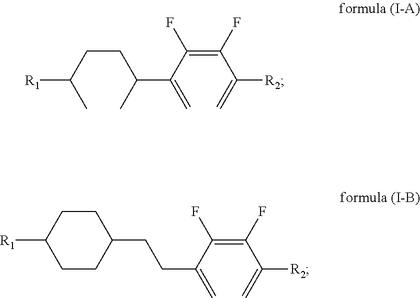

the second compound is represented by formula (II-A) or formula (II-B):

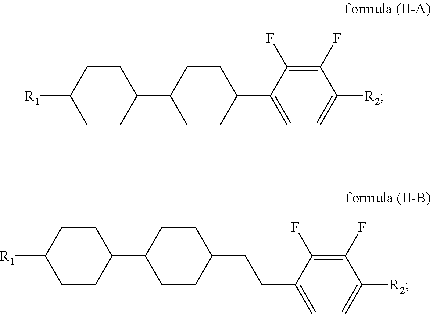

the third compound is represented by formula (III-A) or formula (III-B):

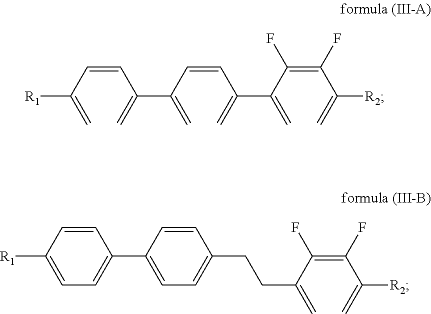

and
the fourth compound is represented by formula (IV):

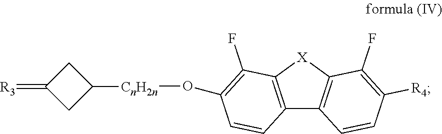

in which X is selected from O or S;
n is an integer greater than or equal to 0 and less than or equal to 7; and
R₁, R₂, R₃, and R₄ are independently selected from H, F, Cl, Br, I, CN, SCN, NCS, SF₅, a substituted or unsubstituted alkyl group having 1-15 carbon atoms, a substituted or unsubstituted alkoxy group having 1-15 carbon atoms, a substituted or unsubstituted alkenyl group having 2-15 carbon atoms, a substituted or unsubstituted alkenyloxy group having 2-15 carbon atoms, a substituted or unsubstituted alkynyl group having 2-15 carbon atoms, or a substituted or unsubstituted alkynyloxy group having 2-15 carbon atoms.

In the present disclosure, the term “at least one” refers to one, two, or more than two. When the liquid crystal composition includes two or more than two compounds, the two or more than two compounds are selected from different compounds represented by the same formula. For example, when the liquid crystal composition includes two first compounds, the two first compounds are selected from two different compounds represented by the formula (I) mentioned above.

In the first compound represented by formula (I-A) or formula (I-B), a cyclohexyl group and a phenyl group are linked through a single bond or a linear alkyl group having two carbon atoms, which is conducive to maintaining the rod-like structure of the first compound and convenient for the nematic phase arrangement of the liquid crystal composition for display panels. The first compound in the liquid crystal composition has a lower clearing point and a lower viscosity, which is conducive to increasing the response speed of display panels using the liquid crystal composition.

In the second compound represented by formula (II-A) or formula (II-B), a cyclohexyl group and a phenyl group are linked through a single bond or a linear alkyl group having two carbon atoms, which is conducive to maintaining the rod-like structure of the second compound and convenient for the nematic phase arrangement of the liquid crystal composition for display panels. The second compound in the liquid crystal composition has a higher clearing point and a higher viscosity, and is used to adjust the viscosity of the liquid crystal composition and increase the clearing point of the liquid crystal composition, so as to facilitate improving the high-temperature resistance of the liquid crystal composition.

In the third compound represented by formula (III-A) or formula (III-B), a phenyl group substituted by fluorine and a phenyl group adjacent to the fluorine-substituted phenyl group are linked through a single bond or a linear alkyl group having two carbon atoms, which is conducive to maintaining the rod-like structure of the third compound and convenient for the nematic phase arrangement of the liquid crystal composition for display panels. The third compound in the liquid crystal composition has a higher clearing point, a higher viscosity, and a higher optical anisotropy value, so as to adjust the viscosity of the liquid crystal composition, increase the clearing point of the liquid crystal composition, and adjust the optical anisotropy value of the liquid crystal composition within a suitable range, thereby improving the light transmittance of the liquid crystal composition, ensuring the light transmittance of the liquid crystal composition to be within a suitable range, and avoiding the optical anisotropy value of the liquid crystal composition from affecting the optical property of the liquid crystal composition.

The fourth compound in the liquid crystal composition has a higher clearing point, a moderate viscosity, a higher dielectric anisotropy value, and a higher optical anisotropy value, and is used to adjust the clearing point and the optical anisotropy value of the liquid crystal composition and increase the dielectric anisotropy value of the liquid crystal composition, which is conducive to reducing the driving voltage for display panels using the liquid crystal composition and improving the response time of display panels using the liquid crystal composition.

By introducing the first compound, the second compound, the third compound, and the fourth compound in the liquid crystal composition, the embodiments of the present disclosure improve the properties of the liquid crystal composition, such as clearing point, viscosity, elastic coefficient, and the like, thereby improving the response time of display panels using the liquid crystal composition.

In some embodiments, the substituted alkyl group having 1-15 carbon atoms, the substituted alkoxy group having 1-15 carbon atoms, the substituted alkenyl group having 2-15 carbon atoms, the substituted alkenyloxy group having 2-15 carbon atoms, the substituted alkynyl group having 2-15 carbon atoms, and the substituted alkynyloxy group having 2-15 carbon atoms independently satisfy at least one of the following conditions:
one or more end groups in above groups are independently mono-substituted by CN or CF₃;
one or more —CH₂— groups in the above groups are independently replaced by —O—, —S—, —SO₂—, —CO—, —C(O)O—, —OC(O)—, —OC(O)O—, —CF₂O—, —OCF₂—, —CH₂—CH₂—, —(CH₂)₃—, —CF₂—CF₂—, —CF₂—CH₂—, —CH₂—CF₂—, —CHF—CHF—, —CH₂O—, —OCH₂—, —CF═CH—, —CH—CF—, —CF═CF—, —CH═CH—, or —C═C—, and heteroatoms therein directly linked to C are not directly linked to each other; and
at least one H in the above groups is substituted by F, Cl, Br, or I.

In some embodiments, at least one of R₁, R₂, R₃, and R₄ is selected from a substituted alkyl group having 1-15 carbon atoms, a substituted alkoxy group having 1-15 carbon atoms, a substituted alkenyl group having 2-15 carbon atoms, a substituted alkenyloxy group having 2-15 carbon atoms, a substituted alkynyl group having 2-15 carbon atoms, or a substituted alkynyloxy group having 2-15 carbon atoms, and one or more end groups in at least one of R₁, R₂, R₃, and R₄ are independently mono-substituted by H, CN, or CF₃.

In some embodiments, at least one of R₁, R₂, R₃, and R₄ is selected from a substituted alkyl group having 1-15 carbon atoms, a substituted alkoxy group having 1-15 carbon atoms, a substituted alkenyl group having 2-15 carbon atoms, a substituted alkenyloxy group having 2-15 carbon atoms, a substituted alkynyl group having 2-15 carbon atoms, or a substituted alkynyloxy group having 2-15 carbon atoms, and one or more-CH₂-groups in at least one of R₁, R₂, R₃, and R₄ are independently replaced by —O—, —S—, —SO₂—, —CO—, —C(O)O—, —OC(O)—, —OC(O)O—, —CF₂O—, —OCF₂—, —CH₂—CH₂—, —(CH₂)₃—, —CF₂—CF₂—, —CF₂—CH₂—, —CH₂—CF₂—, —CHF—CHF—, —CH₂O—, —OCH₂—, —CF═CH—, —CH═CF—, —CF═CF—, —CH—CH—, or —C═C—, and heteroatoms therein directly linked to C are not directly linked to each other.

In some embodiments, at least one of R₁, R₂, R₃, and R₄ is selected from H, a substituted alkyl group having 1-15 carbon atoms, a substituted alkoxy group having 1-15 carbon atoms, a substituted alkenyl group having 2-15 carbon atoms, a substituted alkenyloxy group having 2-15 carbon atoms, a substituted alkynyl group having 2-15 carbon atoms, or a substituted alkynyloxy group having 2-15 carbon atoms, and at least one H in at least one of R₁, R₂, R₃, and R₄ is substituted by F, Cl, Br, or I. In some embodiments, at least one of R₁, R₂, R₃, and R₄ is selected from H, a substituted alkyl group having 1-15 carbon atoms, a substituted alkoxy group having 1-15 carbon atoms, a substituted alkenyl group having 2-15 carbon atoms, a substituted alkenyloxy group having 2-15 carbon atoms, a substituted alkynyl group having 2-15 carbon atoms, or a substituted alkynyloxy group having 2-15 carbon atoms, and at least one H in each of R₁, R₂, R₃, and R₄ is substituted by F, Cl, Br, or I.

In some embodiments, all of H atoms, end groups, and —CH₂— groups in the unsubstituted alkyl group having 1-15 carbon atoms, the unsubstituted alkoxy group having 1-15 carbon atoms, the unsubstituted alkenyl group having 2-15 carbon atoms, the unsubstituted alkenyloxy group having 2-15 carbon atoms, the unsubstituted alkynyl group having 2-15 carbon atoms, and the unsubstituted alkynyloxy group having 2-15 carbon atoms are not substituted or replaced.

In some embodiments, R₁, R₂, R₃, and R₄ are independently selected from H, F, Cl, Br, a substituted or unsubstituted alkyl group having 1-7 carbon atoms, a substituted or unsubstituted alkoxy group having 1-7 carbon atoms, a substituted or unsubstituted alkenyl group having 2-7 carbon atoms, a substituted or unsubstituted alkenyloxy group having 2-7 carbon atoms, a substituted or unsubstituted alkynyl group having 2-7 carbon atoms, or a substituted or unsubstituted alkynyloxy group having 2-7 carbon atoms. When at least one of R₁ and R₂ is selected from a substituted alkyl group, a substituted alkoxy group, a substituted alkenyl group, a substituted alkenyloxy group, a substituted alkynyl group, or a substituted alkynyloxy group, at least one H in each of the above groups is substituted by F, Cl, Br, or I. When at least one of R₃ and R₄ is selected from a substituted alkyl group, a substituted alkoxy group, a substituted alkenyl group, a substituted alkenyloxy group, a substituted alkynyl group, or a substituted alkynyloxy group, at least one H in each of the above groups is substituted by F, Cl, Br, or I.

Preferably, R₁, R₂, R₃, and R₄ are independently selected from H, F, an unsubstituted alkyl group having 1-7 carbon atoms, an unsubstituted alkoxy group having 1-7 carbon atoms, an unsubstituted alkenyl group having 2-7 carbon atoms, an unsubstituted alkenyloxy group having 2-7 carbon atoms, an unsubstituted alkynyl group having 2-7 carbon atoms, or an unsubstituted alkynyloxy group having 2-7 carbon atoms.

More preferably, R₁, R₂, R₃, and R₄ are independently selected from H, F, an unsubstituted alkyl group having 1-5 carbon atoms, an unsubstituted alkoxy group having 1-5 carbon atoms, or an unsubstituted alkenyl group having 2-5 carbon atoms.

In some embodiments, R₁, R₂, R₃, and R₄ are independently selected from an unsubstituted alkyl group, an unsubstituted alkenyl group, or an unsubstituted alkynyl group. The unsubstituted alkyl group, and the unsubstituted alkenyl group, and the unsubstituted alkynyl group are aliphatic hydrocarbon groups.

In some embodiments, R₁, R₂, R₃, and R₄ are independently selected from an unsubstituted alkyl group, and the unsubstituted alkyl group may be an unsubstituted linear alkyl group or an unsubstituted branched alkyl group, preferably an unsubstituted linear alkyl group. In some embodiments, R₁, R₂, R₃, and R₄ are unsubstituted linear alkyl groups having 1-7 carbon atoms, for example, methyl, ethyl, propyl, butyl, pentyl, hexyl, or heptyl.

In some embodiments, when R₁, R₂, R₃, and R₄ are independently selected from an unsubstituted alkenyl group, the unsubstituted alkenyl group may be an unsubstituted linear alkenyl group or an unsubstituted branched alkenyl group. The unsubstituted alkenyl group may be an isomer of E-configuration or Z-configuration and have at least one carbon-carbon double bond. For example, the unsubstituted alkenyl group may be an unsubstituted linear alkenyl group having 2-7 carbon atoms, preferably vinyl, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-5-enyl, hept-5-enyl, hept-6-enyl, or the like.

In some embodiments, R₁, R₂, R₃, and R₄ are independently selected from an unsubstituted alkynyl group, and the unsubstituted alkynyl group may be an unsubstituted linear alkynyl group or an unsubstituted branched alkynyl group, and have at least one carbon-carbon triple bond. For example, the unsubstituted alkynyl group may be an unsubstituted linear alkynyl group having 2-7 carbon atoms, preferably acetylenyl, prop-1-ynyl, prop-2-ynyl, but-1-ynyl, but-2-ynyl, but-3-ynyl, pent-1-ynyl, pent-2-ynyl, pent-3-ynyl, pent-4-ynyl, hex-1-ynyl, hex-2-ynyl, hex-3-ynyl, hex-4-ynyl, hex-5-ynyl, hept-1-ynyl, hept-2-ynyl, hept-3-ynyl, hept-4-ynyl, hept-5-ynyl, hept-6-ynyl, or the like; more preferably selected from prop-2-ynyl, but-2-ynyl, but-3-ynyl, pent-2-ynyl, pent-3-ynyl, or pent-4-ynyl.

In some embodiments, n is an integer greater than or equal to 0 and less than or equal to 7, for example, 0, 1, 2, 3, 4, 5, 6, or 7. Preferably, n is 1 or 2.

In some embodiments, the liquid crystal composition further includes at least one fifth compound represented by formula (V):

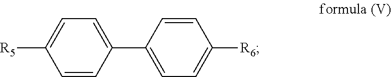

in which R₅ and R₆ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms; and H atoms in R₅ and R₆ are not substituted or at least one of H atoms in R₅ and R₆ is substituted by F, Cl, Br, or I.

The fifth compound in the liquid crystal composition has a higher optical anisotropy value and a lower viscosity, which is conducive to adjusting the optical anisotropy value of the liquid crystal composition, so that the optical anisotropy value of the liquid crystal composition can be within a suitable range and the viscosity of the liquid crystal composition can be reduced, so as to improve the response speed of display panels using the liquid crystal composition.

In some embodiments, R₅ and R₆ are independently selected from an unsubstituted alkyl group having 1-10 carbon atoms, an unsubstituted alkoxy group having 1-10 carbon atoms, an unsubstituted alkenyl group having 2-10 carbon atoms, an unsubstituted alkenyloxy group having 2-10 carbon atoms, an unsubstituted alkynyl group having 2-10 carbon atoms, or an unsubstituted alkynyloxy group having 2-10 carbon atoms, and H atoms in R₅ and R₆ are not substituted.

In some embodiments, a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, and a substituted alkynyloxy group having 2-10 carbon atoms independently satisfy the following condition: at least one of H atoms in the groups is substituted by F, Cl, Br, or I.

In some embodiments, at least one of R₅ and R₆ is selected from a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, or a substituted alkynyloxy group having 2-10 carbon atoms, and at least one of H atoms in R₅ and R₆ is substituted by F, Cl, Br, or I.

In some embodiments, R₅ and R₆ are independently selected from a substituted or unsubstituted alkyl group having 1-7 carbon atoms, a substituted or unsubstituted alkoxy group having 1-7 carbon atoms, or a substituted or unsubstituted alkenyl group having 2-7 carbon atoms. Preferably, R₅ and R₆ are independently selected from an unsubstituted alkyl group having 1-7 carbon atoms, an unsubstituted alkoxy group having 1-7 carbon atoms, or an unsubstituted alkenyl group having 2-7 carbon atoms.

More preferably, R₅ and R₆ are independently selected from an unsubstituted alkyl group having 1-5 carbon atoms, an unsubstituted alkoxy group having 1-5 carbon atoms, or an unsubstituted alkenyl group having 2-5 carbon atoms.

In some embodiments, R₅ and R₆ are independently selected from an unsubstituted alkyl group, and the unsubstituted alkyl group may be an unsubstituted linear alkyl group or an unsubstituted branched alkyl group, preferably an unsubstituted linear alkyl group. In some embodiments, R₅ and R₆ are independently selected from an unsubstituted linear alkyl group having 1-7 carbon atoms, for example, methyl, ethyl, propyl, butyl, pentyl, hexyl, or heptyl.

In some embodiments, when R₅ and R₆ are independently selected from an unsubstituted alkenyl group, the unsubstituted alkenyl group may be an unsubstituted linear alkenyl group or an unsubstituted branched alkenyl group. The unsubstituted alkenyl group may be an isomer of E-configuration or Z-configuration and have at least one carbon-carbon double bond. For example, the unsubstituted alkenyl group may be an unsubstituted linear alkenyl group having 2-7 carbon atoms, preferably vinyl, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-5-enyl, hept-5-enyl, hept-6-enyl, or the like.

In some embodiments, the liquid crystal composition further includes at least one sixth compound represented by formula (VI):

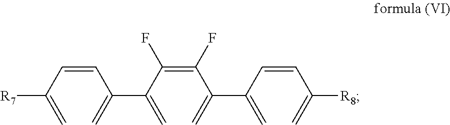

in which R₇ and R₈ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms, and H atoms in R₇ and R₈ are not substituted or at least one of H atoms in R₇ and R₈ is substituted by F, Cl, Br, or I.

The sixth compound in the liquid crystal composition is a compound with negative dielectric anisotropy and has a higher clearing point, a higher optical anisotropy value, and a lower viscosity, so as to adjust the clearing point and the optical anisotropy value of the liquid crystal composition, which is conducive to increasing the response speed of display panels using the liquid crystal composition, and thus improving the response time of display panels using the liquid crystal composition.

In some embodiments, R₇ and R₈ are independently selected from an unsubstituted alkyl group having 1-10 carbon atoms, an unsubstituted alkoxy group having 1-10 carbon atoms, an unsubstituted alkenyl group having 2-10 carbon atoms, an unsubstituted alkenyloxy group having 2-10 carbon atoms, an unsubstituted alkynyl group having 2-10 carbon atoms, or an unsubstituted alkynyloxy group having 2-10 carbon atoms, and H atoms in R₇ and R₈ are not substituted.

In some embodiments, a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, and a substituted alkynyloxy group having 2-10 carbon atoms independently satisfy the following condition: at least of H atoms in the groups is substituted by F, Cl, Br, or I.

In some embodiments, at least one of R₇ and Ra is selected from a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, or a substituted alkynyloxy group having 2-10 carbon atoms, and at least one of H atoms in R₇ and R₈ is substituted by F, Cl, Br, or I.

In some embodiments, R₇ and R₈ are independently selected from a substituted or unsubstituted alkyl group having 1-7 carbon atoms, a substituted or unsubstituted alkoxy group having 1-7 carbon atoms, or a substituted or unsubstituted alkenyl group having 2-7 carbon atoms. Preferably, R₇ and R₈ are independently selected from an unsubstituted alkyl group having 1-7 carbon atoms, an unsubstituted alkoxy group having 1-7 carbon atoms, or an unsubstituted alkenyl group having 2-7 carbon atoms.

More preferably, R₇ and R₈ are independently selected from an unsubstituted alkyl group having 1-5 carbon atoms, an unsubstituted alkoxy group having 1-5 carbon atoms, or an unsubstituted alkenyl group having 2-5 carbon atoms.

In some embodiments, R₇ and R₈ are independently selected from an unsubstituted alkyl group, and the unsubstituted alkyl group may be an unsubstituted linear alkyl group or an unsubstituted branched alkyl group, preferably an unsubstituted linear alkyl group. In some embodiments, R₇ and R₈ are independently selected from an unsubstituted linear alkyl group having 1-7 carbon atoms, for example, methyl, ethyl, propyl, butyl, pentyl, hexyl, or heptyl.

In some embodiments, when R₅ and R₆ are independently selected from an unsubstituted alkenyl group, the unsubstituted alkenyl group may be an unsubstituted linear alkenyl group or an unsubstituted branched alkenyl group. The unsubstituted alkenyl group may be an isomer of E-configuration or Z-configuration and have at least one carbon-carbon double bond. For example, the unsubstituted alkenyl group may be an unsubstituted linear alkenyl group having 2-7 carbon atoms, preferably vinyl, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-5-enyl, hept-5-enyl, hept-6-enyl, or the like.

In some embodiments, the liquid crystal composition further includes at least one seventh compound represented by formula (VII):

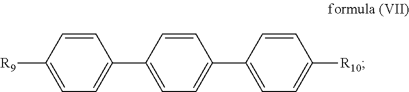

in which R₉ and R₁₀ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms, and H atoms in R₉ and R₁₀ are not substituted or at least one of H atoms in R₉ and R₁₀ is substituted by F, Cl, Br, or I.

The seventh compound in the liquid crystal composition has a higher clearing point and a higher optical anisotropy value, which can improve the clearing point of the liquid crystal composition and adjust the optical anisotropy value of the liquid crystal composition, so as to improve the high-temperature resistance of the liquid crystal composition and increase the light transmittance of the liquid crystal composition within a suitable range.

In some embodiments, R₉ and R₁₀ are independently selected from an unsubstituted alkyl group having 1-10 carbon atoms, an unsubstituted alkoxy group having 1-10 carbon atoms, an unsubstituted alkenyl group having 2-10 carbon atoms, an unsubstituted alkenyloxy group having 2-10 carbon atoms, an unsubstituted alkynyl group having 2-10 carbon atoms, or an unsubstituted alkynyloxy group having 2-10 carbon atoms, and H atoms in R₉ and R₁₀ are not substituted.

In some embodiments, a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, and a substituted alkynyloxy group having 2-10 carbon atoms independently satisfy the following condition: at least one of H atoms in the groups is substituted by F, Cl, Br, or I.

In some embodiments, at least one of R₉ and R₁₀ is selected from a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, or a substituted alkynyloxy group having 2-10 carbon atoms, and at least one of H atoms in R₉ and R₁₀ is substituted by F, Cl, Br, or I.

In some embodiments, R₉ and R₁₀ are independently selected from a substituted or unsubstituted alkyl group having 1-7 carbon atoms, a substituted or unsubstituted alkoxy group having 1-7 carbon atoms, or a substituted or unsubstituted alkenyl group having 2-7 carbon atoms. Preferably, R₉ and R₁₀ are independently selected from an unsubstituted alkyl group having 1-7 carbon atoms, an unsubstituted alkoxy group having 1-7 carbon atoms, or an unsubstituted alkenyl group having 2-7 carbon atoms.

More preferably, R₉ and R₁₀ are independently selected from an unsubstituted alkyl group having 1-5 carbon atoms, an unsubstituted alkoxy group having 1-5 carbon atoms, or an unsubstituted alkenyl group having 2-5 carbon atoms.

In some embodiments, R₉ and R₁₀ are independently selected from an unsubstituted alkyl group, and the unsubstituted alkyl group may be an unsubstituted linear alkyl group or an unsubstituted branched alkyl group, preferably an unsubstituted linear alkyl group. In some embodiments, R₉ and R₁₀ are independently selected from an unsubstituted linear alkyl group having 1-7 carbon atoms, for example, methyl, ethyl, propyl, butyl, pentyl, hexyl, or heptyl.

In some embodiments, when R₉ and R₁₀ are independently selected from an unsubstituted alkenyl group, the unsubstituted alkenyl group may be an unsubstituted linear alkenyl group or an unsubstituted branched alkenyl group. The unsubstituted alkenyl group may be an isomer of E-configuration or Z-configuration and have at least one carbon-carbon double bond. For example, the unsubstituted alkenyl group may be an unsubstituted linear alkenyl group having 2-7 carbon atoms, preferably vinyl, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-5-enyl, hept-5-enyl, hept-6-enyl, or the like.

In some embodiments, the liquid crystal composition further includes at least one eighth compound represented by formula (VIII):

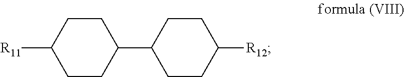

in which Ru and R₁₂ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms, and H atoms in R₁₁ and R₁₂ are not substituted or at least one of H atoms in Ru and R₁₂ is substituted by F, Cl, Br, or I.

The eighth compound in the liquid crystal composition has a lower clearing point and a lower viscosity, which is conducive to increasing the response speed of display panels using the liquid crystal composition, thereby further reducing the response time of display panels using the liquid crystal composition.

In some embodiments, a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, and a substituted alkynyloxy group having 2-10 carbon atoms independently satisfy the following condition: at least one of H atoms in the groups is substituted by F, Cl, Br, or I.

In some embodiments, at least one of R₁₁ and R₁₂ is selected from a substituted alkyl group having 1-10 carbon atoms, a substituted alkoxy group having 1-10 carbon atoms, a substituted alkenyl group having 2-10 carbon atoms, a substituted alkenyloxy group having 2-10 carbon atoms, a substituted alkynyl group having 2-10 carbon atoms, or a substituted alkynyloxy group having 2-10 carbon atoms, and at least one of H atoms in R₁₁ and R₁₂ is substituted by F, Cl, Br, or I.

In some embodiments, R₁₁ and R₁₂ are independently selected from a substituted or unsubstituted alkyl group having 1-7 carbon atoms, a substituted or unsubstituted alkoxy group having 1-7 carbon atoms, or a substituted or unsubstituted alkenyl group having 2-7 carbon atoms. Preferably, R₁₁ and R₁₂ are independently selected from an unsubstituted alkyl group having 1-7 carbon atoms, an unsubstituted alkoxy group having 1-7 carbon atoms, or an unsubstituted alkenyl group having 2-7 carbon atoms.

More preferably, R₁₁ and R₁₂ are independently selected from an unsubstituted alkyl group having 1-5 carbon atoms, an unsubstituted alkoxy group having 1-5 carbon atoms, or an unsubstituted alkenyl group having 2-5 carbon atoms.

In some embodiments, when R₁₁ and R₁₂ are independently selected from an unsubstituted alkyl group, the unsubstituted alkyl group may be an unsubstituted linear alkyl group or an unsubstituted branched alkyl group, preferably an unsubstituted linear alkyl group. In some embodiments, R₉ and R₁₀ are independently selected from an unsubstituted linear alkyl group having 1-7 carbon atoms, for example, methyl, ethyl, propyl, butyl, pentyl, hexyl, or heptyl.

In some embodiments, when R₁₁ and R₁₂ are independently selected from an unsubstituted alkenyl group, the unsubstituted alkenyl group may be an unsubstituted linear alkenyl group or an unsubstituted branched alkenyl group. The unsubstituted alkenyl group may be an isomer of E-configuration or Z-configuration and have at least one carbon-carbon double bond. For example, the unsubstituted alkenyl group may be an unsubstituted linear alkenyl group having 2-7 carbon atoms, preferably vinyl, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-5-enyl, hept-5-enyl, hept-6-enyl, or the like.

In some embodiments, a mass percentage of the first compound in the liquid crystal composition is greater than or equal to 1% and less than or equal to 35% by mass, for example, 3%, 5%, 10%, 15%, 20%, 25%, 30%, or the like; a mass percentage of the second compound in the liquid crystal composition is greater than or equal to 1% and less than or equal to 35% by mass, for example, 3%, 5%, 10%, 15%, 20%, 25%, 30%, or the like; a mass percentage of the third compound in the liquid crystal composition is greater than or equal to 1% and less than or equal to 30% by mass, for example, 3%, 5%, 10%, 15%, 20%, 25%, or the like; and a mass percentage of the fourth compound in the liquid crystal composition is greater than or equal to 1% and less than or equal to 30% by mass, for example, 3%, 5%, 10%, 15%, 20%, 25%, or the like.

Preferably, the mass percentage of the first compound in the liquid crystal composition is greater than or equal to 5% and less than or equal to 30%, for example, 8%, 10%, 12%, 15%, 18%, 20%, 25%, 28%, or the like; the mass percentage of the second compound in the liquid crystal composition is greater than or equal to 5% and less than or equal to 30%, for example, 8%, 10%, 12%, 15%, 18%, 20%, 25%, 28%, or the like; the mass percentage of the third compound in the liquid crystal composition is greater than or equal to 5% and less than or equal to 25%, for example, 5%, 8%, 10%, 12%, 15%, 20%, 22%, or the like; and the mass percentage of the fourth compound in the liquid crystal composition is greater than or equal to 1% and less than or equal to 25%, for example, 3%, 5%, 10%, 15%, 20%, or the like.

More preferably, the mass percentage of the first compound in the liquid crystal composition is greater than or equal to 5% and less than or equal to 25%, for example, 8%, 10%, 12%, 15%, 18%, 20%, or the like; the mass percentage of the second compound in the liquid crystal composition is greater than or equal to 5% and less than or equal to 25%, for example, 8%, 10%, 12%, 15%, 18%, 20%, or the like; the mass percentage of the third compound in the liquid crystal composition is greater than or equal to 5% and less than or equal to 15%, for example, 8%, 9%, 10%, 11%, 12%, 14%, or the like; and the mass percentage of the fourth compound in the liquid crystal composition is greater than or equal to 1% and less than or equal to 15%, for example, 3%, 5%, 8%, 10%, 11%, 12%, 14%, or the like.

Best preferably, the mass percentage of the first compound in the liquid crystal composition is greater than or equal to 5% and less than or equal to 18%, for example, 8%, 10%, 12%, 13%, 15%, 16%, or the like; the mass percentage of the second compound in the liquid crystal composition is greater than or equal to 5% and less than or equal to 20%, for example, 6%, 8%, 10%, 12%, 15%, 18%, or the like; the mass percentage of the third compound in the liquid crystal composition is greater than or equal to 5% and less than or equal to 12%, for example, 6%, 7%, 8%, 9%, 10%, 11%, or the like; and the mass percentage of the fourth compound in the liquid crystal composition is greater than or equal to 1% and less than or equal to 10%, for example, 2%, 3%, 4%, 5%, 6%, 7%, 8%, 9%, or the like.

In some embodiments, when the liquid crystal composition further includes the fifth compound, a mass percentage of the fifth compound in the liquid crystal composition is greater than or equal to 1% and less than or equal to 30% by mass, for example, 3%, 5%, 10%, 15%, 20%, 25%, or the like. Preferably, the mass percentage of the fifth compound in the liquid crystal composition is greater than or equal to 3% and less than or equal to 20%, for example, 5%, 8%, 10%, 15%, 18%, or the like. More preferably, the mass percentage of the fifth compound in the liquid crystal composition is greater than or equal to 5% and less than or equal to 15%, for example, 6%, 8%, 10%, 12%, or the like.

In some embodiments, when the liquid crystal composition further includes the sixth compound, a mass percentage of the sixth compound in the liquid crystal composition is greater than or equal to 1% and less than or equal to 20% by mass, for example, 3%, 5%, 10%, 15%, 18%, or the like. Preferably, the mass percentage of the sixth compound in the liquid crystal composition is greater than or equal to 3% and less than or equal to 15%, for example, 5%, 8%, 10%, 12%, or the like. More preferably, the mass percentage of the sixth compound in the liquid crystal composition is greater than or equal to 3% and less than or equal to 10%, for example, 4%, 5%, 6%, 7%, 8%, 9%, or the like.

In some embodiments, when the liquid crystal composition further includes the seventh compound, a mass percentage of the seventh compound in the liquid crystal composition is greater than or equal to 1% and less than or equal to 15% by mass, for example, 2%, 3%, 5%, 10%, 12%, or the like. Preferably, the mass percentage of the seventh compound in the liquid crystal composition is greater than or equal to 1% and less than or equal to 10%, for example, 2%, 3%, 5%, 8%, or the like. More preferably, the mass percentage of the seventh compound in the liquid crystal composition is greater than or equal to 2% and less than or equal to 6%, for example, 3%, 4%, 5%, or the like.

In some embodiments, a mass percentage of the eighth compound in the liquid crystal composition is greater than or equal to 15% and less than or equal to 70% by mass, for example, 18%, 20%, 22%, 25%, 28%, 30%, 32%, 35%, 38%, 38%, 40%, 42%, 45%, 46%, 48%, 50%, 52%, 55%, 58%, 60%, 62%, 65%, 68%, or the like. Preferably, the mass percentage of the eighth compound in the liquid crystal composition is greater than or equal to 20% and less than or equal to 60%.

In some embodiments, the optical anisotropy value of the liquid crystal composition at a temperature of 25° C. is greater than or equal to 0.09 and less than or equal to 0.22, for example, 0.1, 0.105, 0.11, 0.115, 0.125, 0.15, 0.175, 0.2, 0.21, or the like. By setting the optical anisotropy value of the liquid crystal composition being within a suitable range, the light transmittance of the liquid crystal composition can be increased, so as to ensure the light transmittance of the liquid crystal composition to be within a suitable range, thereby avoiding the optical anisotropy value from affecting the optical properties of the liquid crystal composition.

In some embodiments, the rotational viscosity of the liquid crystal composition at a temperature of 25° C. is greater than or equal to 40 mPa's and less than or equal to 100 mPa's, for example, 45 mPa·s, 50 mPa·s, 55 mPa·s, 60 mPa·s, 65 mPa·s, 70 mPa·s, 75 mPa·s, 80 mPa·s, 85 mPa·s, 90 mPa·s, 95 mPa's, or the like. By setting the rotational viscosity of the liquid crystal composition being within a suitable range, the rotational speed of the liquid crystal composition at a temperature of 25° C. can be increased, so as to ensure the response time of the liquid crystal composition to be within a suitable range, thereby avoiding the rotational viscosity from affecting the properties of the liquid crystal composition.

In some embodiments, the bending elastic coefficient of the liquid crystal composition is greater than or equal to 10 and less than or equal to 26, for example, 11, 12, 13, 14, 15, 18, 20, 22, 24, 25, or the like; and/or, the splaying elastic coefficient of the liquid crystal composition is greater than or equal to 10 and less than or equal to 26, for example, 12, 13, 14, 15, 18, 20, 22, 24, 25, or the like. By setting the bending elastic coefficient and/the splaying elastic coefficient of the liquid crystal composition being within the above-mentioned ranges, it is conducive to obtaining a suitable average value between the bending elastic coefficient and the splaying elastic coefficient of the liquid crystal composition, which can effectively improve the response speed of display panels using the liquid crystal composition to obtain a faster response time.

In some embodiments, the dielectric anisotropy value of the liquid crystal composition at a temperature of 25° C. is less than 0 and greater than or equal to −5, for example, −4.8, −4.5, −4, −3.5, −3, −2, −1, or the like, which is conducive to reducing the driving voltage for liquid crystal display panels using the liquid crystal composition, and thus reducing power consumption of liquid crystal display panels using the liquid crystal composition.

In some embodiments, the clearing point of the liquid crystal composition ranges from 70° C. to 135° C., for example, 75° C., 77° C., 78° C., 80° C., 82° C., 88° C., 90° C., 92° C., 95° C., 100° C., 105° C., 110° C., 115° C., 120° C., 125° C., 130° C., or the like, so as to avoid degradation of the high-temperature resistance of the liquid crystal composition caused by a lower clearing point of the liquid crystal composition.

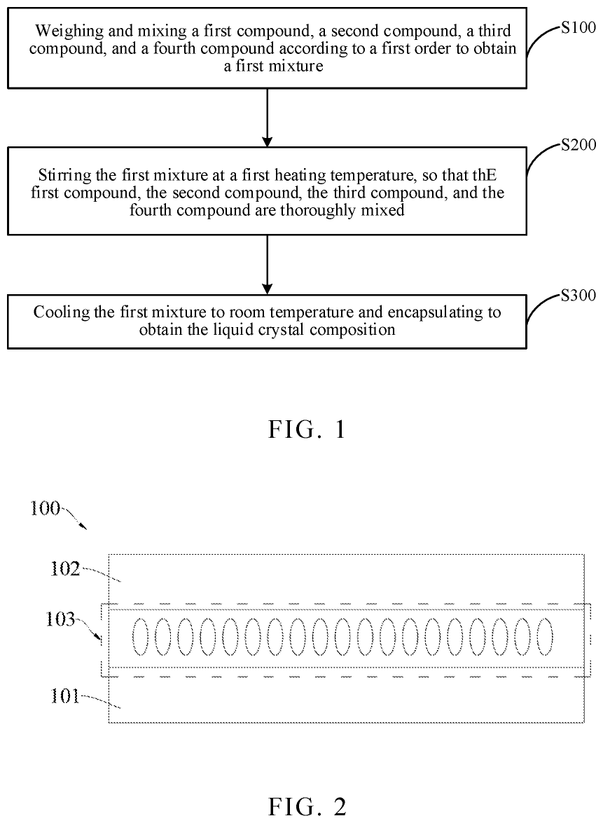

Referring to FIG. 1, embodiments of the present disclosure further provide a method for preparing the above-mentioned liquid crystal composition as follows.

The method for preparing the liquid crystal composition includes the following steps S100, S200, and S300.

In step S100, a first mixture is obtained by weighing and mixing a first compound, a second compound, a third compound, and a fourth compound by mass percentage according to a first order.

The first order is preferably the first compound, the second compound, the third compound, and the fourth compound mixed sequentially in an order of melting points from low to high.

When the liquid crystal composition further includes at least one of the fifth compound, the sixth compound, the seventh compound, and the eighth compound, the fifth compound, the sixth compound, the seventh compound, and the eighth compound are mixed with the first compound, the second compound, the third compound, and the fourth compound according to the first order in the step of obtaining the first mixture.

In step S200, the first mixture is stirred at a first heating temperature, so that the first compound, the second compound, the third compound, and the fourth compound are thoroughly mixed.

In some embodiments, the first heating temperature preferably ranges from 60° C. to 100° C.

When the first mixture includes at least one of the fifth compound, the sixth compound, the seventh compound, and the eighth compound, the fifth compound, the sixth compound, the seventh compound, and the eighth compound are thoroughly mixed with the first compound, the second compound, the third compound, and the fourth compound.

In step S300, the first mixture is cooled to room temperature and encapsulated to obtain the liquid crystal composition.

The following examples 1 to 5 of the present disclosure provide different exemplary combinations of the above-mentioned compounds in liquid crystal compositions.

### Example 1

Structures of compounds in the liquid crystal composition corresponding to the same formula and different formulae, and mass percentages of these compounds provided in the example 1 are shown in table 1.

TABLE 1
Components of liquid crystal composition

| Formula | Structure | Mass percentage (%) |
|---|---|---|
| VIII | 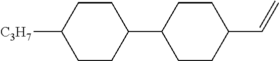 | 32 |
| VIII | 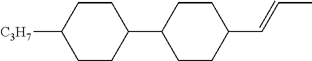 | 6 |
| I-A | 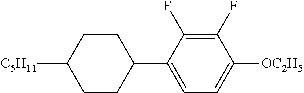 | 5 |
| I-B | 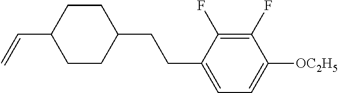 [SMILES: C=CC1CCC(CCc2ccc(OCC)c(F)c2F)CC1] | 13 |
| II-A | 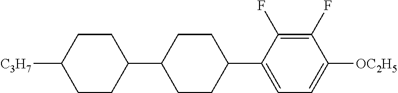 | 8 |
| II-A | 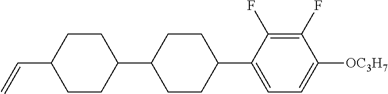 | 6 |
| II-B | 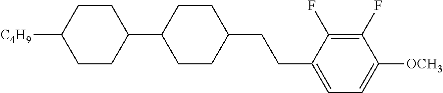 | 6 |
| III-A | 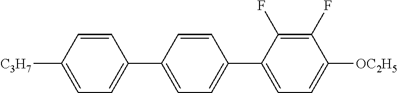 | 5 |
| III-A | 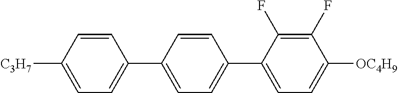 | 3 |
| III-B | 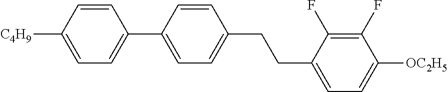 | 5 |
| VI | 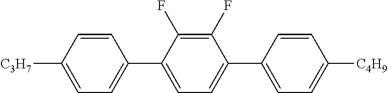 | 2 |
| IV | 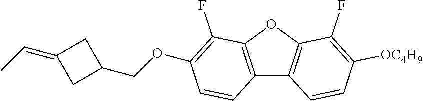 | 3 |
| IV | 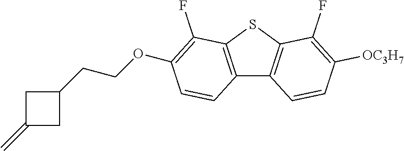 | 6 |

The liquid crystal composition in the example 1 has the following property parameters: Tni of 82° C., γ₁ of 64 mPa·s, Δn of 0.105, ne of 1.582, Δε of −4.3, ε⊥ of 8.0, K₁₁ of 13.2, and K₃₃ of 15.3, and there is no precipitation in the liquid crystal composition at −20° C. for 480 hours. Tni indicates a clearing point of the liquid crystal composition, γ₁ indicates rotational viscosity of the liquid crystal composition at temperature of 25° C., Δn indicates an optical anisotropy value of the liquid crystal composition at temperature of 25° C., ne indicates refractive index of extraordinary ray, Δε indicates a dielectric anisotropy value of the liquid crystal composition at temperature of 25° C., ε⊥ indicates a dielectric constant value of the liquid crystal composition in a direction perpendicular to a long axis of the liquid crystal composition, K₁₁ indicates a splaying elastic coefficient of the liquid crystal composition, and K₃₃ indicates a bending elastic coefficient of the liquid crystal composition.

### Example 2

Structures of compounds in the liquid crystal composition corresponding to the same formula and different formulae, and mass percentages of these compounds provided in the example 2 are shown in table 2.

TABLE 2
Components of liquid crystal composition

| Formula | Structure | Mass percentage (%) |
|---|---|---|
| VIII | 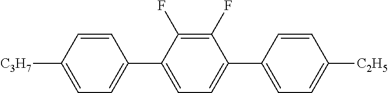 | 33 |
| V | 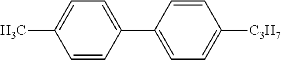 | 2 |
| I-A | 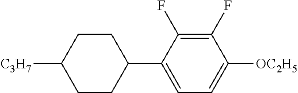 | 13 |
| I-A | 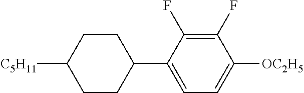 | 5 |
| II-A | 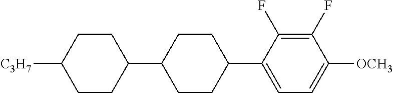 | 8 |
| II-A | 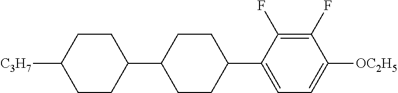 | 10 |
| II-A | 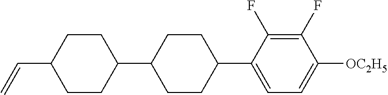 [SMILES: C=CC1CCC(C2CCC(c3ccc(OCC)c(F)c3F)CC2)CC1] | 5 |
| II-B | 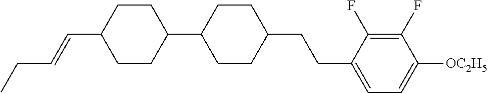 [SMILES: CC/C=C/C1CCC(C2CCC(CCc3ccc(OCC)c(F)c3F)CC2)CC1] | 5 |
| II-B | 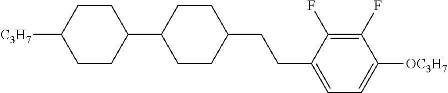 | 7 |
| III-A | 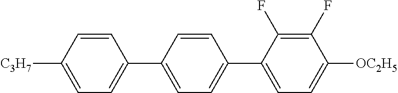 | 1 |
| VI | 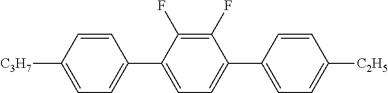 | 9 |
| IV | 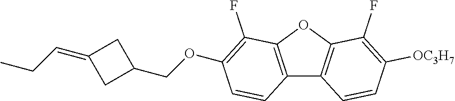 | 2 |

The liquid crystal composition in the example 2 has the following property parameters: Tni of 83° C., γ₁ of 68 mPa·s, Δn of 0.098, ne of 1.565, Δε of −4.0, ε⊥ of 7.8, K₁₁ of 14.5, and K₃₃ of 14.7, and there is no precipitation in the liquid crystal composition at −20° C. for 480 hours.

### Example 3

Structures of compounds in the liquid crystal composition corresponding to the same formula and different formulae, and mass percentages of these compounds provided in the example 3 are shown in table 3.

TABLE 3
Components of liquid crystal composition

| Formula | Structure | Mass percentage (%) |
|---|---|---|
| VIII | 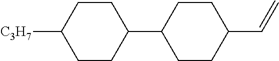 | 33 |
| VIII | 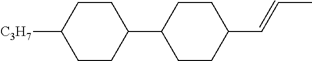 | 13 |
| VII | 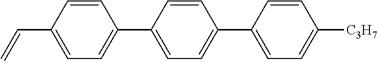 | 2 |
| I-B | 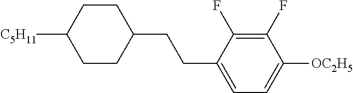 | 5 |
| II-A | 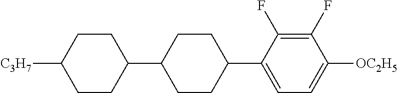 | 1 |
| III-A | 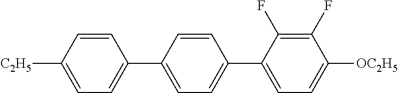 [SMILES: CCOc1ccc(-c2ccc(-c3ccc(CC)cc3)cc2)c(F)c1F] | 6 |
| III-A | 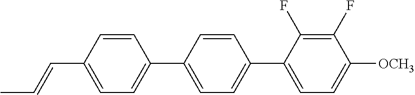 [SMILES: C/C=C/c1ccc(-c2ccc(-c3ccc(OC)c(F)c3F)cc2)cc1] | 6 |
| III-A | 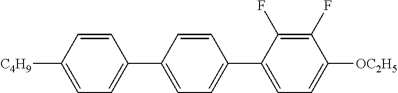 | 6 |
| III-B | 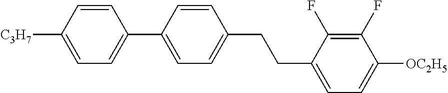 | 6 |
| III-B | 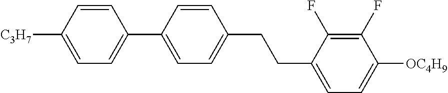 | 6 |
| VI | 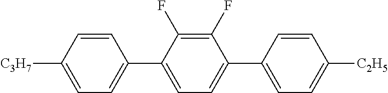 | 9 |
| IV | 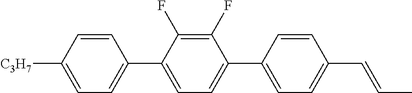 | 5 |
| IV | 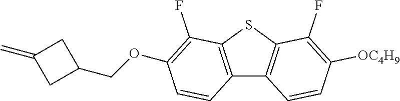 | 2 |

The liquid crystal composition in the example 3 has the following property parameters: Tni of 77° C., γ₁ of 70 mPa·s, Δn of 0.121, ne of 1.633, Δε of −2.4, ε⊥ of 6.3, K₁₁ of 14.5, and K₃₃ of 19.6, and there is no precipitation in the liquid crystal composition at −20° C. for 480 hours.

### Example 4

Structures of compounds in the liquid crystal composition corresponding to the same formula and different formulae, and mass percentages of these compounds provided in the example 4 are shown in table 4.

TABLE 4
Components of liquid crystal composition

| Formula | Structure | Mass percentage (%) |
|---|---|---|
| VIII | 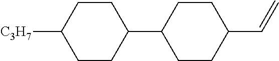 | 20 |
| V | 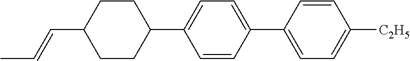 [SMILES: C/C=C/C1CCC(c2ccc(-c3ccc(CC)cc3)cc2)CC1] | 5 |
| V | 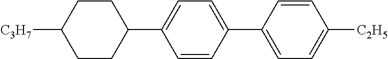 | 6 |
| VII | 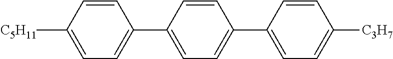 | 2 |
| I-A | 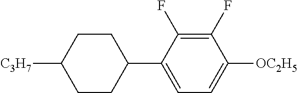 | 13 |
| I-A | 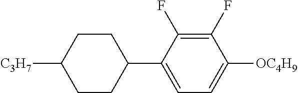 | 6 |
| I-A | 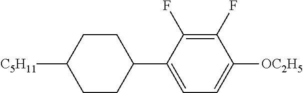 | 10 |
| I-B | 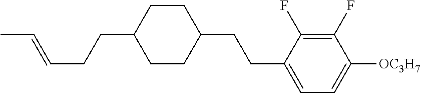 | 6 |
| II-A | 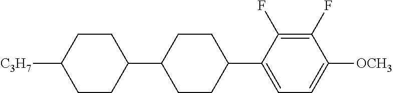 | 8 |
| II-A | 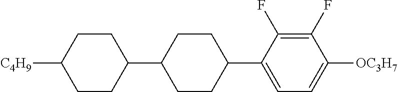 | 3 |
| II-B | 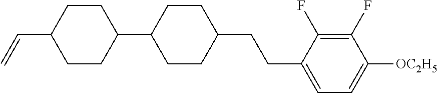 [SMILES: C=CC1CCC(C2CCC(CCc3ccc(OCC)c(F)c3F)CC2)CC1] | 9 |
| III-B | 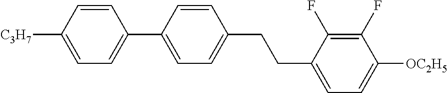 | 4 |
| III-B | 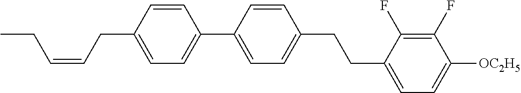 [SMILES: CC/C=C\Cc1ccc(-c2ccc(CCc3ccc(OCC)c(F)c3F)cc2)cc1] | 4 |
| IV | 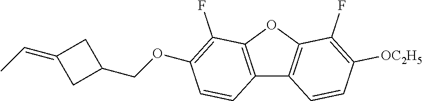 [SMILES: CC=C1CC(COc2ccc3c(oc4c(F)c(OCC)ccc43)c2F)C1] | 4 |

The liquid crystal composition in the example 4 has the following property parameters: Tni of 80° C., γ₁ of 79 mPa·s, Δn of 0.111, ne of 1.591, Δε of −4.7, ε⊥ of 8.5, K₁₁ of 13.5, and K₃₃ of 16.6, and there is no precipitation in the liquid crystal composition at −20° C. for 480 hours.

### Example 5

Structures of compounds in the liquid crystal composition corresponding to the same formula and different formulae, and mass percentages of these compounds provided in the example 5 are shown in table 5. In the liquid crystal composition of the example 5, a compound represented by

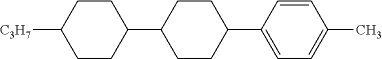

and a compound represented by

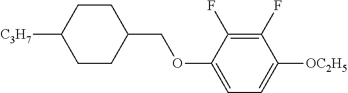

are further added.

TABLE 5
Components of liquid crystal composition

| Formula | Structure | Mass percentage (%) |
|---|---|---|
| VIII | 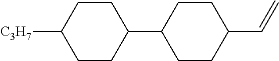 | 35 |
| VIII | 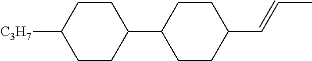 | 6 |
| V | 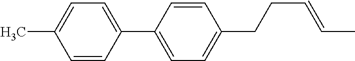 [SMILES: C/C=C/CCc1ccc(-c2ccc(C)cc2)cc1] | 5 |
| | 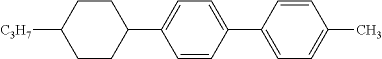 | 3 |
| I-A | 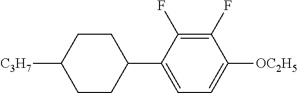 | 1 |
| | 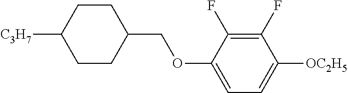 | 10 |
| II-A | 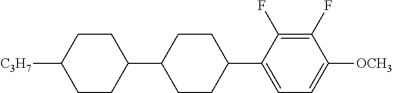 | 5 |
| II-A | 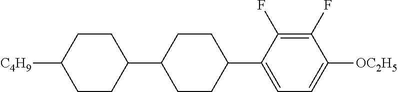 | 4 |
| II-B | 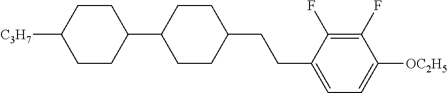 | 9 |
| III-A | 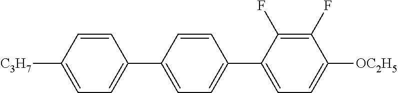 | 4 |
| III-B | 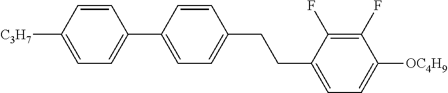 | 4 |
| VI | 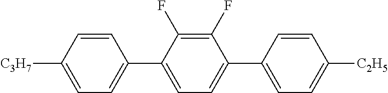 | 2 |
| VI | 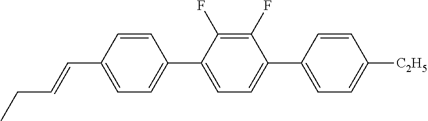 [SMILES: CC/C=C/c1ccc(-c2ccc(-c3ccc(CC)cc3)c(F)c2F)cc1] | 2 |
| IV | 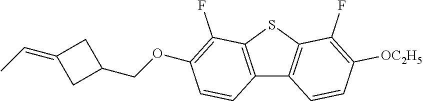 [SMILES: CC=C1CC(COc2ccc3c(sc4c(F)c(OCC)ccc43)c2F)C1] | 5 |
| IV | 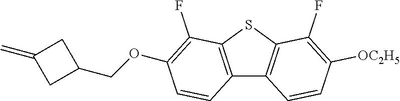 [SMILES: C=C1CC(COc2ccc3c(sc4c(F)c(OCC)ccc43)c2F)C1] | 5 |

The liquid crystal composition in the example 5 has the following property parameters: Tni of 80° C., γ₁ of 56 mPa·s, Δn of 0.107, ne of 1.586, Δε of −3.6, ε⊥ of 7.3, K₁₁ of 13.1, and K₃₃ of 14.7, and there is no precipitation in the liquid crystal composition at −20° C. for 480 hours.

### Comparative Example 1

Structures of compounds in the liquid crystal composition and mass percentages thereof provided in the comparative example 1 are shown in table 6.

TABLE 6
Components of liquid crystal composition

| Structure | Mass percentage (%) |
|---|---|
| 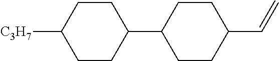 | 35 |
| 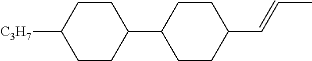 | 6 |
| 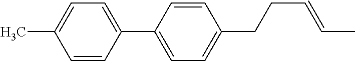 [SMILES: C/C=C/CCc1ccc(-c2ccc(C)cc2)cc1] | 5 |
| 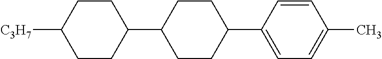 | 3 |
| 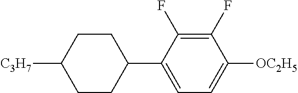 | 1 |
| 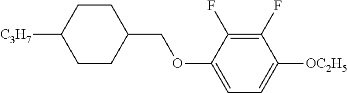 | 10 |
| 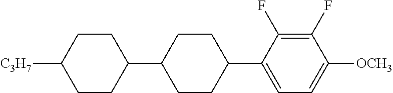 | 10 |
| 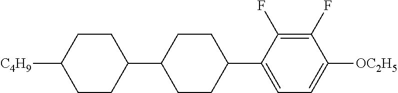 | 9 |
| 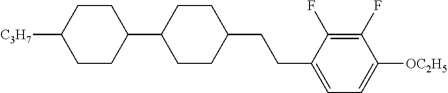 | 9 |
| 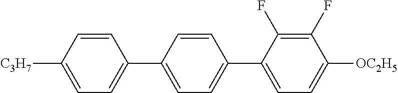 | 4 |
| 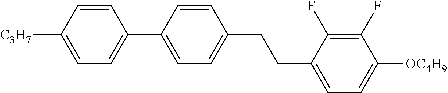 | 4 |
| 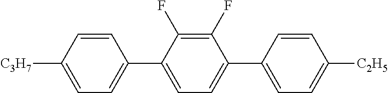 | 2 |
| 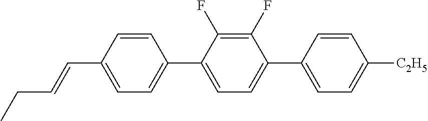 [SMILES: CC/C=C/c1ccc(-c2ccc(-c3ccc(CC)cc3)c(F)c2F)cc1] | 2 |

The liquid crystal composition in the comparative example 1 has the following property parameters: Tni of 78° C., γ₁ of 62 mPa·s, Δn of 0.106, ne of 1.580, Δε of −3.3, ε⊥ of 6.7, K₁₁ of 14.2, and K₃₃ of 15.4, and there is no precipitation in the liquid crystal composition at −20° C. for 480 hours.

### Comparative Example 2

Structures of compounds in the liquid crystal composition and mass percentages thereof provided in the comparative example 2 are shown in table 7.

TABLE 7
Components of liquid crystal composition

| Structure | Mass percentage (%) |
|---|---|
| 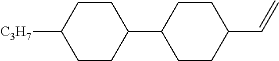 | 24 |
| 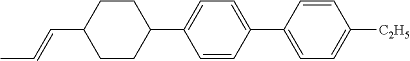 [SMILES: C/C=C/C1CCC(c2ccc(-c3ccc(CC)cc3)cc2)CC1] | 5 |
| 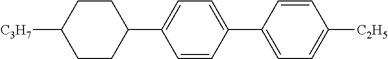 | 6 |
| 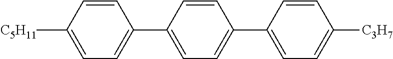 | 2 |
| 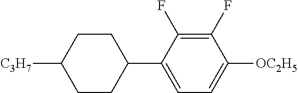 | 13 |
| 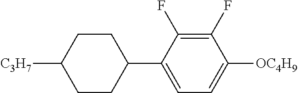 | 6 |
| 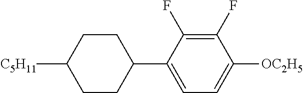 | 10 |
| 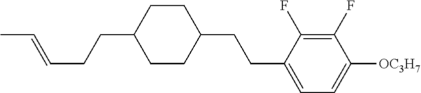 | 6 |
| 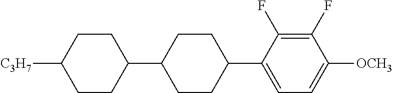 | 8 |
| 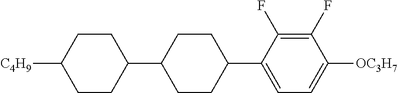 | 3 |
| 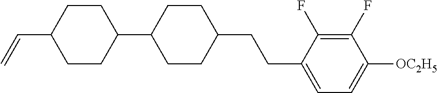 [SMILES: C=CC1CCC(C2CCC(CCc3ccc(OCC)c(F)c3F)CC2)CC1] | 9 |
| 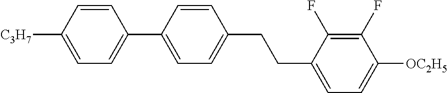 | 4 |
| 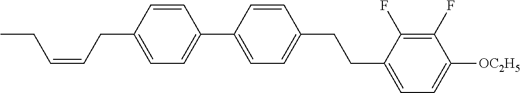 [SMILES: CC/C=C\Cc1ccc(-c2ccc(CCc3ccc(OCC)c(F)c3F)cc2)cc1] | 4 |

The liquid crystal composition in the comparative example 2 has the following property parameters: Tni of 74° C., γ₁ of 75 mPa·s, Δn of 0.104, ne of 1.578, Δε of −3.6, ε⊥ of 7.6, K₁₁ of 12.3, and K₃₃ of 13.7, and there is no precipitation in the liquid crystal composition at −20° C. for 480 hours.

The liquid crystal compositions provided in the examples 1 to 5 have clearing points ranging from 77° C. to 83° C., which make the liquid crystal compositions have good high-temperature resistance; the liquid crystal compositions provided in the examples 1 to 5 have rotational viscosity at the temperature of 25° C. ranging from 56 mPa's to 79 mPa's, making the liquid crystal compositions have higher rotational speed, which helps shorten the response time of display panels using the liquid crystal compositions; the liquid crystal compositions provided in the examples 1 to 5 have optical anisotropy values at the temperature of 25° C. ranging from 0.098 to 0.121 to ensure good light transmittance of display panels using the liquid crystal compositions; the liquid crystal compositions provided in the examples 1 to 5 have dielectric anisotropy values at the temperature of 25° C. ranging from −4.7 to −2.4 to drive display panels using the liquid crystal compositions at lower driving voltages, thereby reducing the power consumption of display panels using the liquid crystal compositions; the liquid crystal compositions provided in the examples 1 to 5 have splaying elastic coefficients of the liquid crystal compositions ranging from 13.1 to 14.5 and bending elastic coefficients of the liquid crystal compositions ranging from 14.7 to 19.6, which improves the average value of the splaying elastic coefficient and the bending elastic coefficient of each of the above liquid crystal compositions, thereby effectively shortening the response time of display panels using the liquid crystal compositions. Compared with the comparative example 1, the fourth compound represented by the formula (IV) is added to the liquid crystal composition of the example 5, which effectively reduces the viscosity of the liquid crystal composition and the ratio of the viscosity to the splaying elasticity coefficient, thereby effectively improving the response speed of display panels using the liquid crystal composition to improve the response time of the display panels. Compared with the comparative example 2, the addition of the fourth compound represented by the formula (IV) in the liquid crystal composition of the example 4 effectively reduces the ratio of the viscosity to the splaying elasticity coefficient of the liquid crystal composition, thereby effectively improving the response speed of display panels using the liquid crystal composition, and further improving the response time of display panels using the liquid crystal composition.

Referring to FIG. 2, embodiments of the present disclosure further provide a display panel 100, which includes a first substrate 101, a second substrate 102 disposed on the first substrate 101, and a liquid crystal layer 103 between the first substrate 101 and the second substrate 102, and the liquid crystal layer 103 includes the liquid crystal composition as described above.

The first substrate 101 may be an array substrate, and the second substrate 102 may be a color film substrate. In some embodiments, when the first substrate 101 is an array substrate, the first substrate 101 includes a first base, an active layer disposed on the first base, a first insulation layer disposed on the active layer, a gate layer disposed on the first insulation layer, a second insulation layer disposed on the gate layer, a source/drain layer disposed on the second insulation layer and including a source and a drain, and a third insulation layer disposed on the source/drain layer. The display panel further includes a common electrode layer and a pixel electrode layer. The pixel electrode layer is disposed on a side of the third insulation layer away from the first base and includes a pixel electrode electrically connected to the source or the drain. The common electrode layer includes a common electrode. In some embodiments, the common electrode layer is disposed on the first substrate 101. For example, the common electrode layer may be disposed between the pixel electrode layer and the source/drain layer, or the common electrode layer is disposed on a side of the pixel electrode layer away from the first base. In some embodiments, the common electrode layer is disposed on the second substrate 102. For example, the second substrate 102 includes a second base, and the common electrode layer is disposed on a side of the second base close to the liquid crystal layer. The display panel further includes a color film layer, and the color film layer is disposed on a side of the first substrate close to the liquid crystal layer or on a side of the second substrate close to the liquid crystal layer.

The display panel 100 may be a display panel with any one of types such as vertical alignment (VA), electronically controlled birefringence (ECB), fringe field switching (FFS), in-plane switching (IPS), and the like.

The embodiments of the present disclosure provide the liquid crystal composition and the display panel using the same as described above. The liquid crystal composition includes the first compound represented by formula (I-A) or formula (I-B), the second compound represented by formula (II-A) or formula (II-B), the third compound represented by formula (III-A) or formula (III-B), and the fourth compound represented by formula (IV). By introducing the combination of the first compound, the second compound, the third compound, and the fourth compound in the liquid crystal composition, the present disclosure improves the properties of the liquid crystal composition, such as clearing point, viscosity, elastic coefficient, and the like, thereby improving the response time of the display panel using the liquid crystal composition.

This context provides a detailed description to the liquid crystal composition and the display panel using the same provided in the embodiments of the present disclosure. In this context, specific embodiments are used to illustrate the principles and core ideas of the present disclosure. The description of the above-mentioned embodiments is only used to help understand the core ideas of the present disclosure. At the same time, for those skilled in the art, according to the core ideas of the present disclosure, there might be changes in specific embodiments and the scope of the present disclosure, which falls within the scope of the protection of the present disclosure.

What is claimed is:

1. A liquid crystal composition comprising a first compound, a second compound, a third compound, and a fourth compound;
wherein the first compound is represented by formula (I-A) or formula (I-B): 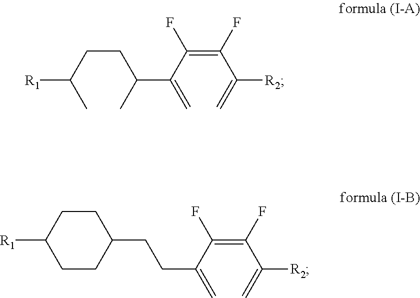
the second compound is represented by formula (II-A) or formula (II-B): 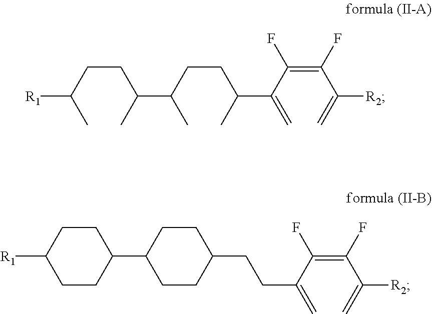
the third compound is represented by formula (III-A) or formula (III-B): 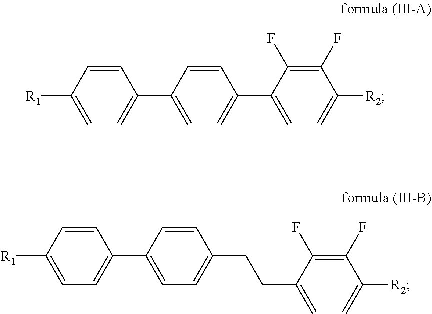
and
the fourth compound is represented by formula (IV): 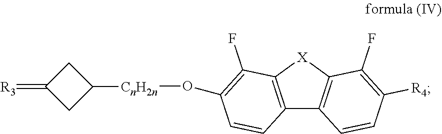
wherein X is selected from O or S;
n is an integer greater than or equal to 0 and less than or equal to 7; and
R₁, R₂, R₃, and R₄ are independently selected from H, F, Cl, Br, I, CN, SCN, NCS, SF₅, a substituted or unsubstituted alkyl group having 1-15 carbon atoms, a substituted or unsubstituted alkoxy group having 1-15 carbon atoms, a substituted or unsubstituted alkenyl group having 2-15 carbon atoms, a substituted or unsubstituted alkenyloxy group having 2-15 carbon atoms, a substituted or unsubstituted alkynyl group having 2-15 carbon atoms, or a substituted or unsubstituted alkynyloxy group having 2-15 carbon atoms.

2. The liquid crystal composition of claim 1, wherein the substituted alkyl group having 1-15 carbon atoms, the substituted alkoxy group having 1-15 carbon atoms, the substituted alkenyl group having 2-15 carbon atoms, the substituted alkenyloxy group having 2-15 carbon atoms, the substituted alkynyl group having 2-15 carbon atoms, and the substituted alkynyloxy group having 2-15 carbon atoms independently satisfy at least one of following conditions:
one or more end groups in above groups are independently mono-substituted by CN or CF₃;
one or more-CH₂-groups in the above groups are independently replaced by —O—, —S—, —SO₂—, —CO—, —C(O)O—, —OC(O)—, —OC(O)O—, —CF₂O—, —OCF₂—, —CH₂—CH₂—,
(CH₂)₃—, —CF₂—CF₂—, —CF₂—CH₂—, —CH₂—CF₂—, —CHF—CHF—, —CH₂O—, —OCH₂—, —CF═CH—, —CH═CF—, —CF═CF—, —CH═CH—, or —C═C—, and heteroatoms therein directly linked to C are not directly linked to each other; and
at least one H in the above groups is substituted by F, Cl, Br, or I.

3. The liquid crystal composition of claim 1, wherein the liquid crystal composition further comprises a fifth compound represented by formula (V): 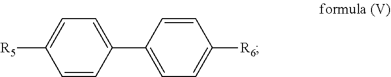
wherein R₅ and R₆ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms, and H atoms in R₅ and R₆ are not substituted or at least one of H atoms in R₅ and R₆ is substituted by F, Cl, Br, or I.

4. The liquid crystal composition of claim 3, wherein a mass percentage of the fifth compound in the liquid crystal composition is greater than or equal to 1% and less than or equal to 30% by mass.

5. The liquid crystal composition of claim 1, wherein the liquid crystal composition further comprises a sixth compound represented by formula (VI): 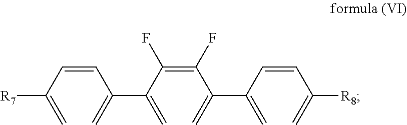
wherein R₇ and R₈ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms, and H atoms in R₇ and R₈ are not substituted or at least one of H atoms in R₇ and R₈ is substituted by F, Cl, Br, or I.

6. The liquid crystal composition of claim 5, wherein a mass percentage of the sixth compound in the liquid crystal composition is greater than or equal to 1% and less than or equal to 20% by mass.

7. The liquid crystal composition of claim 1, wherein the liquid crystal composition further comprises a seventh compound represented by formula (VII): 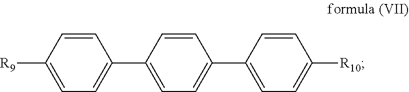
wherein R₉ and R₁₀ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms, and H atoms in R₉ and R₁₀ are not substituted or at least one of H atoms in R₉ and R₁₀ is substituted by F, Cl, Br, or I.

8. The liquid crystal composition of claim 7, wherein a mass percentage of the seventh compound in the liquid crystal composition is greater than or equal to 1% and less than or equal to 15% by mass.

9. The liquid crystal composition of claim 1, wherein a mass percentage of the first compound in the liquid crystal composition is greater than or equal to 1% and less than or equal to 35% by mass;
a mass percentage of the second compound in the liquid crystal composition is greater than or equal to 1% and less than or equal to 35% by mass;
a mass percentage of the third compound in the liquid crystal composition is greater than or equal to 1% and less than or equal to 30% by mass; and
a mass percentage of the fourth compound in the liquid crystal composition is greater than or equal to 1% and less than or equal to 30% by mass.

10. The liquid crystal composition of claim 1, wherein R₁, R₂, R₃, and R₄ are independently selected from H, F, Cl, Br, a substituted or unsubstituted alkyl group having 1-7 carbon atoms, a substituted or unsubstituted alkoxy group having 1-7 carbon atoms, a substituted or unsubstituted alkenyl group having 2-7 carbon atoms, a substituted or unsubstituted alkenyloxy group having 2-7 carbon atoms, a substituted or unsubstituted alkynyl group having 2-7 carbon atoms, or a substituted or unsubstituted alkynyloxy group having 2-7 carbon atoms.

11. The liquid crystal composition of claim 1, wherein R₁, R₂, R₃, and R₄ are independently selected from H, F, an unsubstituted alkyl group having 1-5 carbon atoms, an unsubstituted alkoxy group having 1-5 carbon atoms, or an unsubstituted alkenyl group having 2-5 carbon atoms.

12. The liquid crystal composition of claim 1, wherein R₁, R₂, R₃, and R₄ are independently selected from methyl, ethyl, propyl, butyl, pentyl, hexyl, heptyl, vinyl, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-5-enyl, hept-5-enyl, or hept-6-enyl.

13. The liquid crystal composition of claim 1, wherein n is selected from 1 or 2.

14. The liquid crystal composition of claim 1, wherein the liquid crystal composition further comprises a fifth compound represented by formula (V): 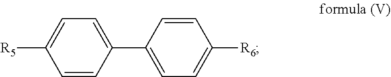
wherein R₅ and R₆ are independently selected from a substituted or unsubstituted alkyl group having 1-7 carbon atoms, a substituted or unsubstituted alkoxy group having 1-7 carbon atoms, or a substituted or unsubstituted alkenyl group having 2-7 carbon atoms, and H atoms in R₅ and R₆ are not substituted or at least one of H atoms in R₅ and R₆ is substituted by F, Cl, Br, or I.

15. The liquid crystal composition of claim 1, wherein the liquid crystal composition further comprises a sixth compound represented by formula (VI): 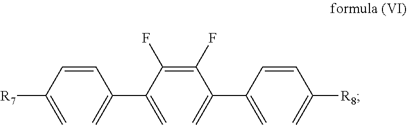
wherein R₇ and R₈ are independently selected from a substituted or unsubstituted alkyl group having 1-7 carbon atoms, a substituted or unsubstituted alkoxy group having 1-7 carbon atoms, or a substituted or unsubstituted alkenyl group having 2-7 carbon atoms, and H atoms in R₇ and R₈ are not substituted or at least one of H atoms in R₇ and R₈ is substituted by F, Cl, Br, or I.

16. The liquid crystal composition of claim 1, wherein the liquid crystal composition further comprises a seventh compound represented by formula (VII): 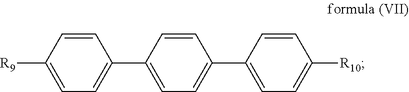
wherein R₉ and R₁₀ are independently selected from a substituted or unsubstituted alkyl group having 1-7 carbon atoms, a substituted or unsubstituted alkoxy group having 1-7 carbon atoms, or a substituted or unsubstituted alkenyl group having 2-7 carbon atoms, and H atoms in R₉ and R₁₀ are not substituted or at least one of H atoms in R₉ and R₁₀ is substituted by F, Cl, Br, or I.

17. The liquid crystal composition of claim 1, wherein the liquid crystal composition further comprises an eighth compound represented by formula (VIII): 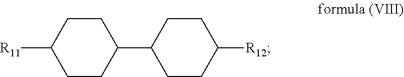
wherein R₁₁ and R₁₂ are independently selected from a substituted or unsubstituted alkyl group having 1-10 carbon atoms, a substituted or unsubstituted alkoxy group having 1-10 carbon atoms, a substituted or unsubstituted alkenyl group having 2-10 carbon atoms, a substituted or unsubstituted alkenyloxy group having 2-10 carbon atoms, a substituted or unsubstituted alkynyl group having 2-10 carbon atoms, or a substituted or unsubstituted alkynyloxy group having 2-10 carbon atoms, and H atoms in R₁₁ and R₁₂ are not substituted or at least one of H atoms in R₉ and R₁₀ is substituted by F, Cl, Br, or I.

18. The liquid crystal composition of claim 1, wherein a rotational viscosity of the liquid crystal composition at a temperature of 25° C. is greater than or equal to 40 mPa·s and less than or equal to 100 mPa·s; and both of a bending elastic coefficient and a splaying elastic coefficient of the liquid crystal composition are greater than or equal to 10 and less than or equal to 26.

19. The liquid crystal composition of claim 1, wherein a dielectric anisotropy value of the liquid crystal composition at a temperature of 25° C. is greater than or equal to −5 and less than 0; an optical anisotropy value of the liquid crystal composition at a temperature of 25° C. is greater than or equal to 0.09 and less than or equal to 0.22; and a clearing point of the liquid crystal composition is greater than 70° C. and less than 135° C.

20. A display panel comprising a first substrate, a second substrate disposed on the first substrate, and a liquid crystal layer between the first substrate and the second substrate;
wherein the liquid crystal layer comprises a liquid crystal composition comprising a first compound, a second compound, a third compound, and a fourth compound;
wherein the first compound is represented by formula (I-A) or formula (I-B): 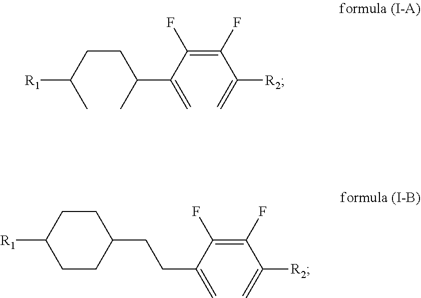
the second compound is represented by formula (II-A) or formula (II-B): 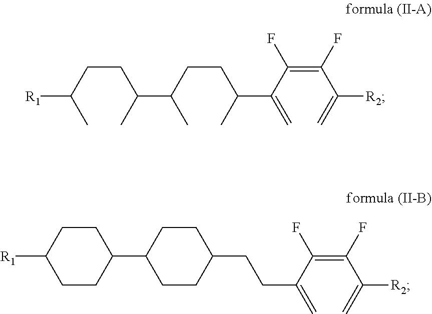
the third compound is represented by formula (III-A) or formula (III-B): 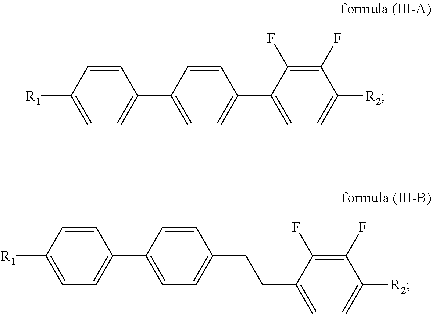
and
the fourth compound is represented by formula (IV): 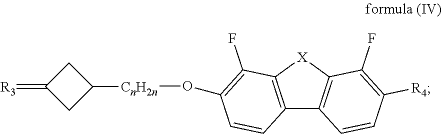
wherein X is selected from O or S;
n is an integer greater than or equal to 0 and less than or equal to 7; and
R₁, R₂, R₃, and R₄ are independently selected from H, F, Cl, Br, I, CN, SCN, NCS, SF₅, a substituted or unsubstituted alkyl group having 1-15 carbon atoms, a substituted or unsubstituted alkoxy group having 1-15 carbon atoms, a substituted or unsubstituted alkenyl group having 2-15 carbon atoms, a substituted or unsubstituted alkenyloxy group having 2-15 carbon atoms, a substituted or unsubstituted alkynyl group having 2-15 carbon atoms, or a substituted or unsubstituted alkynyloxy group having 2-15 carbon atoms.
